(19) United States
(12) Patent Application Publication
(10) Pub. No.: US 2022/0266069 A1
(43) Pub. Date: Aug. 25, 2022

(54) Medical Grade Reusable and Washable Fabric/Cloth Face Mask

(71) Applicant: Orly Ben Ben Garti, Tel Aviv (IL)

(72) Inventor: Orly Ben Ben Garti, Tel Aviv (IL)

(21) Appl. No.: 17/185,342

(22) Filed: Feb. 25, 2021

(51) Int. Cl. A62B 23/02; A41D 13/11; B32B 5/02; B32B 5/26; A62B 7/10; A62B 18/08

(52) U.S. Cl. CPC A62B 23/025; A41D 13/1138; B32B 5/022; B32B 5/26; A62B 7/10; A62B 18/084; A41D 2500/30; B32B 2262/0253; B32B 2535/00; B32B 2262/062; B32B 2262/0276

(57) ABSTRACT

A medical grade reusable and washable fabric/cloth face mask comprising a plurality of filtration layers located between a first and last layer of top quality cotton, polyester or other suitable fabric. In at least one embodiment, the present invention consists of an N95 grade filter. In other embodiments, the face mask consists of a plurality of non woven polypropylene melt blown material. The invention provides a high level of filtration and can be washed and reused.

### FIELD OF INVENTION

The present invention relates to a personal protective equipment (PPE) and more particularly, a medical grade reusable and washable fabric/cloth face mask designed with a plurality of filtration layers to protect the user from harmful airborne pathogens.

### BACKGROUND OF INVENTION

The use of protective face masks is not a new phenomenon; usually, they are worn to prevent the user from inhaling pathogens which, may cause harm to the health. Protective face masks are commonly used in heath institutions by doctors and other medical workers in health facilities. In recent times and most especially due to outbreaks of new airborne diseases such as COVID-19, it has become necessary for even ordinary citizens to own and use a protective face mask.

### DESCRIPTION OF RELATED ART

Traditionally, medical face masks are made of soft breathable materials that make use of filters to sterilize the air intake of the user against airborne microbes/pathogens. The problem with them is that they are not reusable as they cannot be washed, therefore, they must be disposed after use which creates an environmental crisis and therefore, by addressing one crisis, we are creating another one.

Face masks produced with regular fabrics such as cotton can be washed and reused, however the fabrics themselves cannot guarantee an effective filtration of airborne pathogens resulting a low level of protection for the user of such face mask.

The present invention aims to provide a solution to the aforementioned problems. Due to the shortcomings associated with regular face masks discussed above, it is desirable to have a face mask that has a high level of filtration and can be washed and reused.

### SUMMARY OF THE INVENTION

The following summary discloses all the features and functions of the present invention. By considering the whole specification, claims, drawings and abstract, one can easily get a full understanding of the invention and how it functions.

The present invention may come in different variations under three major categories namely: Shield, Rider and Olson face masks. The invention discloses a reusable and washable medical grade face mask which is made of a plurality of different fabric layers (which includes a fashionable/esthetically designed layer). The invention consists of the first layer made of top quality cotton or any other suitable fabric (on the frontal part of the mask), a plurality of filtration layers made of non-woven melt-blown fabrics (Polypropylene), and a last 1-2 layers/linings made of top quality cotton fabric (on the inner side of the face mask—the part that touches the user's face). The filtration layers are located in between the first and last layers. The invention is reusable as it can be washed and still maintain a high level of filtration. It is important to note that the cotton layers facilitate the washable feature of the present invention as they protect the filtration layers in between them from getting damaged or losing their filtration efficiency.

In one embodiment, (the Shield face mask), the invention is available in a medical-grade surgical mask filtration level. This mask consists of 2 fabric layers besides the filtration layers. The invention further consists of straps which may be in form of ear loops made of rubber band (to allow the user to wear the mask around the ears) made of nylon, rayon or spandex. The invention also comprises a nose clip fixed into an invisible tunnel inside the mask. The mask is designed to be washable and reused while at the same time maintaining a high level of filtration.

In another embodiment, (the Olson face mask), the invention is available in two filtration levels. (i) Medical-grade surgical mask filtration level and (ii) N95 medical-grade level. Both filtration levels offered consists of 3 fabric layers besides the filtration layers. This mask comprises a last layer of fabric located after the last layer/lining. This layer forms a pocket on the inner side of the facemask and allows the user to fix an extra layer of filter into the same pocket if desired. The invention further consists of straps which may be in form of ear loops made of rubber band (to allow the user to wear the mask around the ears) or headband (for wearing around the back of the head) made of nylon, rayon or spandex. The invention also comprises a nose clip fixed into a tunnel inside the mask. The mask is designed to be washable and reused while at the same time maintaining a high level of filtration.

In another embodiment, (the Rider face mask), the invention is available in a medical-grade surgical mask filtration level. This mask consists of 2 fabric layers besides the filtration layers when the lining layer of this mask forms a pocket on the inner side of the facemask and allows the user to fix an extra layer of filter into the same pocket if desired. The invention further consists of straps which may be in form of ear loops made of rubber band (to allow the user to wear the mask around the ears) or headband (for wearing around the back of the head) made of nylon, rayon or spandex. The mask is designed to be washable and reused while at the same time maintaining a high level of filtration.

### BRIEF DESCRIPTION OF THE DRAWINGS

FIG. 1 discloses a frontal perspective view of the present invention according to the first embodiment (Shield face mask);

FIG. 2 discloses a back perspective view of the first embodiment;

FIG. 3 discloses a perspective view of the present invention according to the first embodiment showing how it is worn by a user;

FIG. 4 discloses a frontal perspective view of the present invention according to the second embodiment (Olson face mask);

FIG. 5 discloses a back view of the invention according to the second embodiment;

FIG. 6 discloses a perspective view of the present invention according to the second embodiment showing how it is worn by a user;

FIG. 7 discloses a frontal perspective view of the present invention according to the third embodiment (rider face mask);

FIG. 8 discloses a back perspective view of the third embodiment of the present invention;

FIG. 9 shows how the third embodiment of the present invention is worn by the user;

FIG. 10 discloses a frontal perspective view of the present invention according to the first embodiment (shield face mask designed for babies);

FIG. 11 shows how the first embodiment (shield face mask designed for babies) of the present invention is worn by the user;

FIG. 12 shows the perspective view of the present invention according to the third embodiment (rider face mask designed for kids);

FIG. 13 shows how the third embodiment (rider face mask designed for kids) of the present invention is worn by the user;

FIG. 14 shows the filtration layers of the first embodiment (shield face masks)

FIG. 15 shows the filtration layers of the second embodiment (Non N95 Olson face mask) of the present invention;

FIG. 16 shows the filtration layers of the second embodiment (N95 Olson 5 layer face mask) of the present invention;

FIG. 17 shows the filtration layers of the second embodiment (N95 Olson 6 layer face mask) of the present invention;

FIG. 18 shows the filtration layers of the third embodiment (rider face masks) of the present invention;

### DETAILED DESCRIPTION OF DRAWINGS

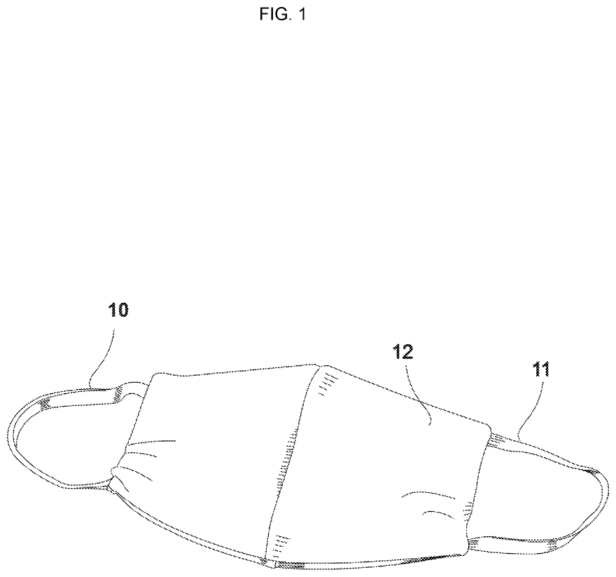

The invention will now be described in detail with references made to the accompanying drawings according to FIG. 1-18.

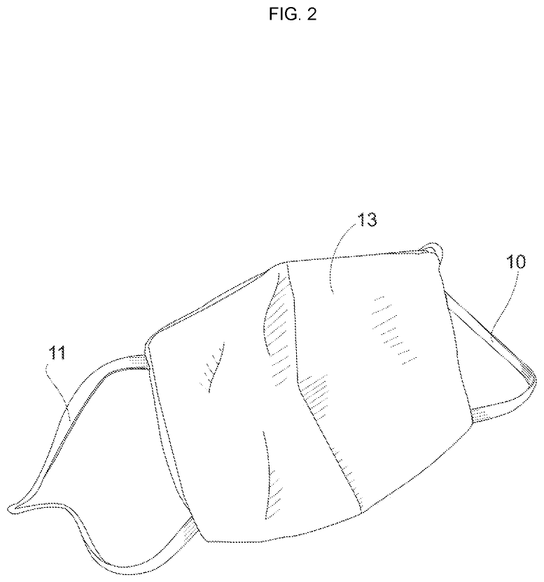

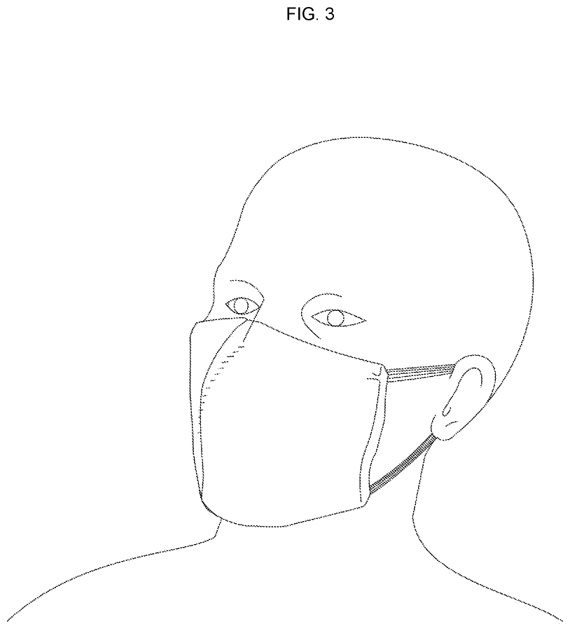

FIG. 1-2 discloses a medical grade face mask according to the first embodiment (shield face mask). FIG. 1 comprising the outer layer 12 (frontal part of the mask), and twin straps 10, 11. FIG. 2 comprises the inside view of the mask consisting of the last layer/lining 13 (the side that touches the user's face) and the straps 10, 11. In FIG. 3, an illustration of the first embodiment of the present invention being worn by a user is disclosed.

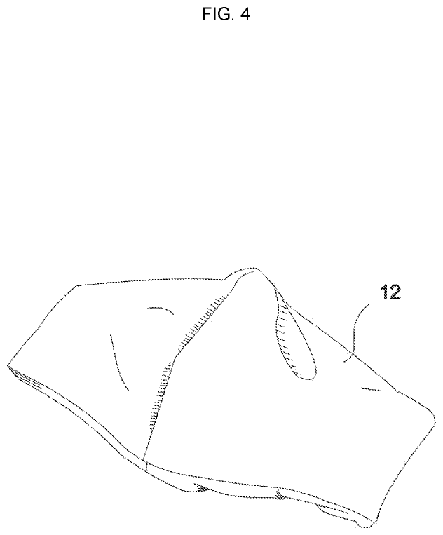

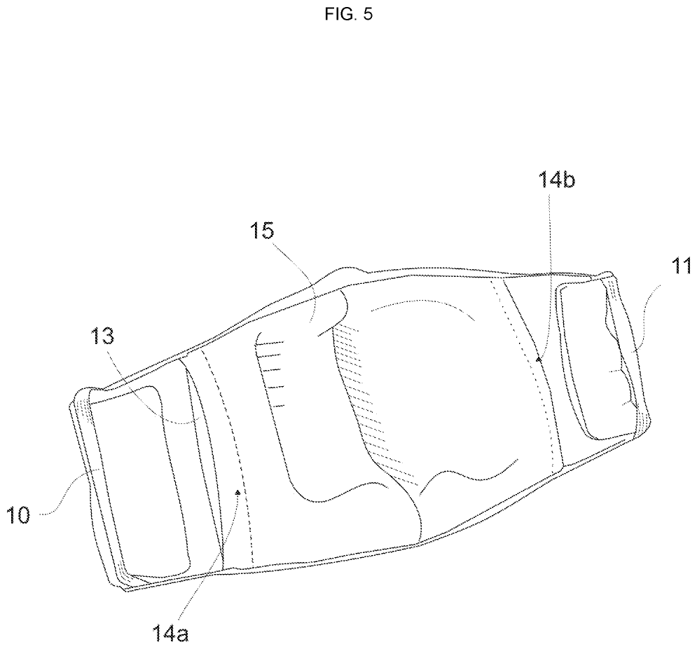

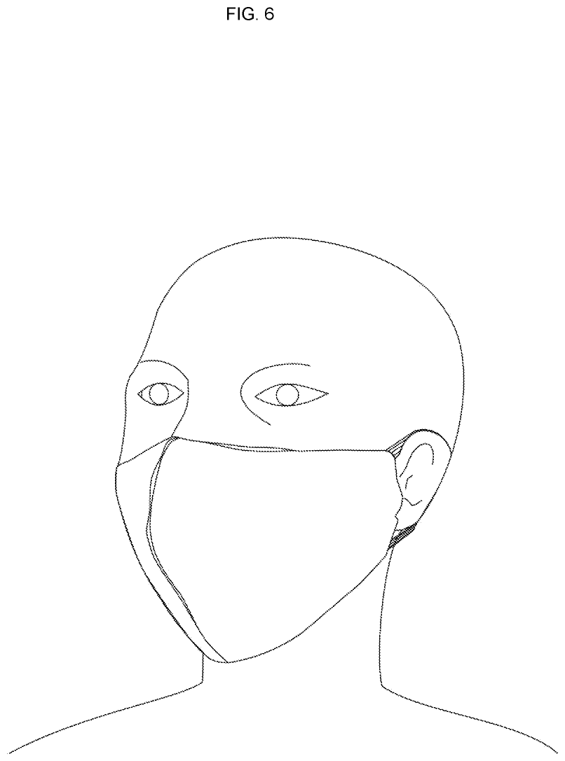

FIG. 4-6, discloses a medical grade face mask according to the second embodiment (Olson face mask). FIG. 4 comprises the outer layer 12 (frontal/external part of the mask). FIG. 5 shows the inside view of the mask consisting of the two last layers/lining, 13 which is the inner lining layer and another layer of fabric 15 (the side that touches the user's face). This fabric layer 15 forms a pocket 14a, 14b on the inner side of the facemask and allows the user to fix an extra layer of filter into the said pocket if desired. FIG. 5 also consists of the straps 10, 11. FIG. 6 is an illustration showing how the mask is worn by the user.

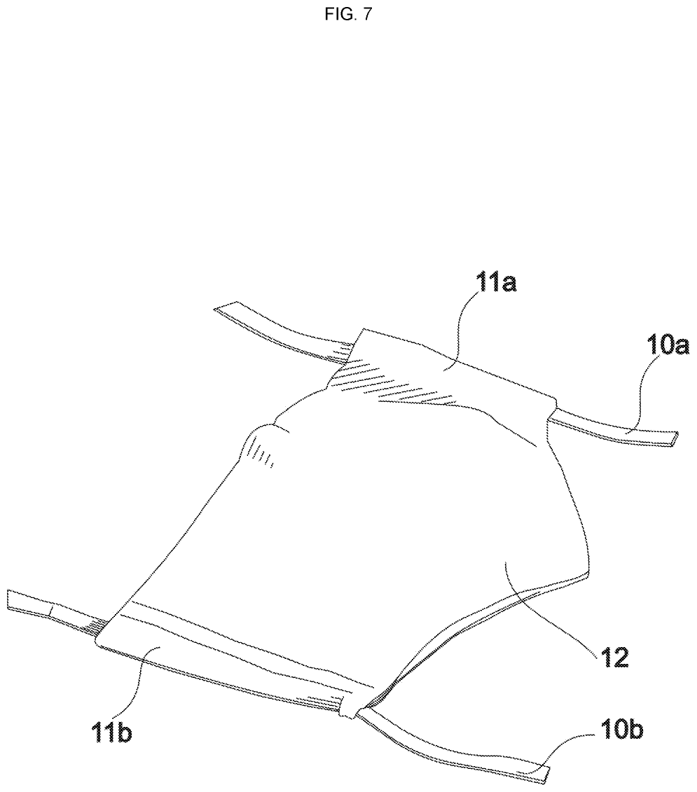

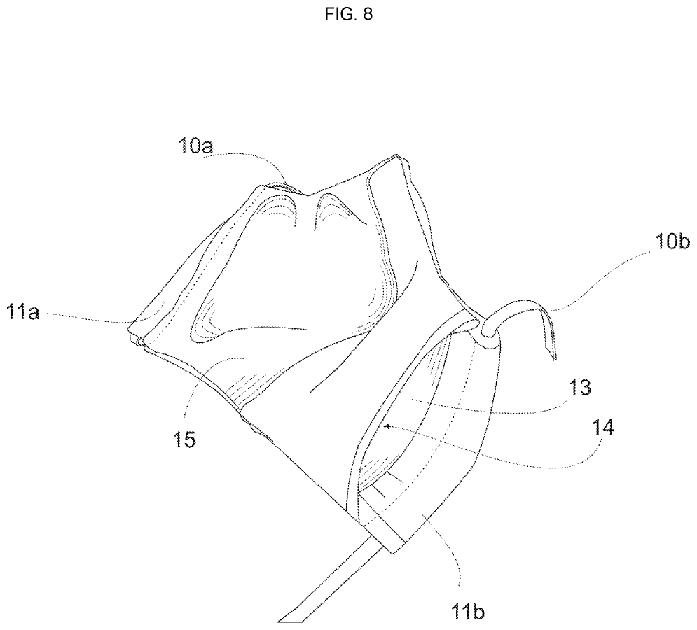

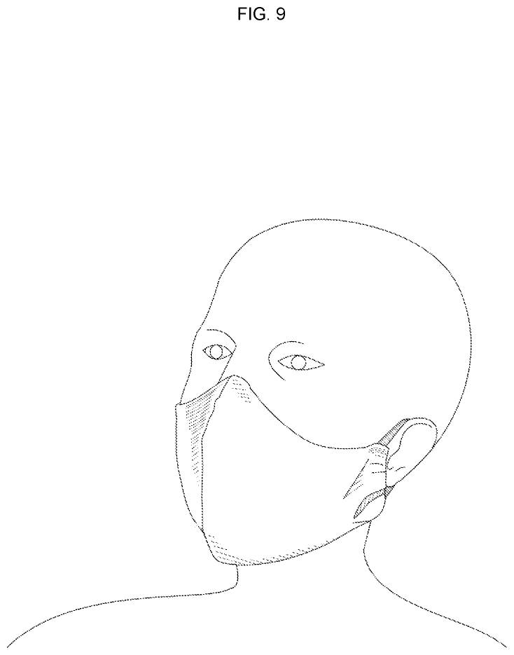

FIG. 7 discloses the third embodiment of the present invention (Rider Face mask). The invention consists of the outer layer 12 (frontal part of the mask), and the straps 10a, 10b and the tunnels of where the straps are being inserted 11a and 11b. FIG. 8 discloses the inside view of the third embodiment showing the filtration layer 13 and the last fabric layer/lining 15. This fabric layer 15 forms a pocket 14 on the inner side of the facemask and allows the user to fix an extra layer of filter into the said pocket if desired. FIG. 8 also consists of the straps 10a, 10b and the tunnels of where the straps are being inserted 11a, and 11b. FIG. 9 discloses an illustration showing how the mask is worn by the user.

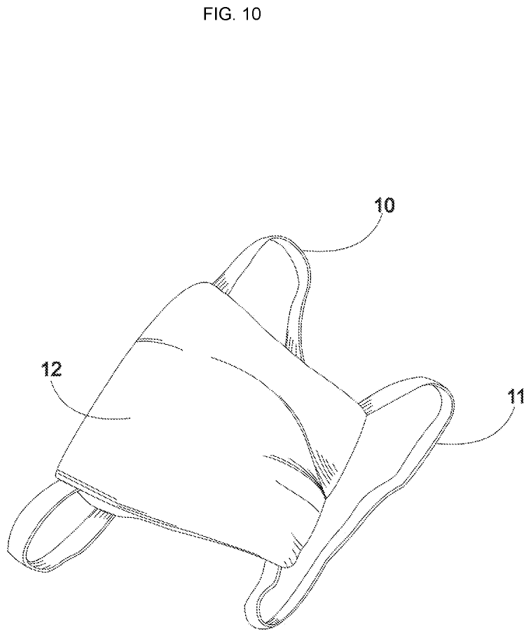

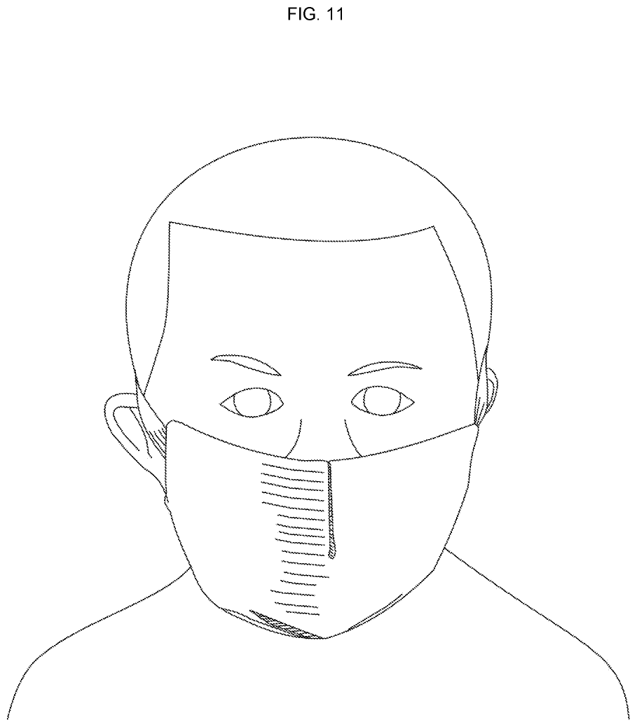

In FIG. 10, the first embodiment of the invention is disclosed (Shield mask designed for babies). The invention consists of the outer layer 12 (front of the mask), and the straps/headband 10 and 11. FIG. 11 discloses an illustration showing how the mask is worn by the user.

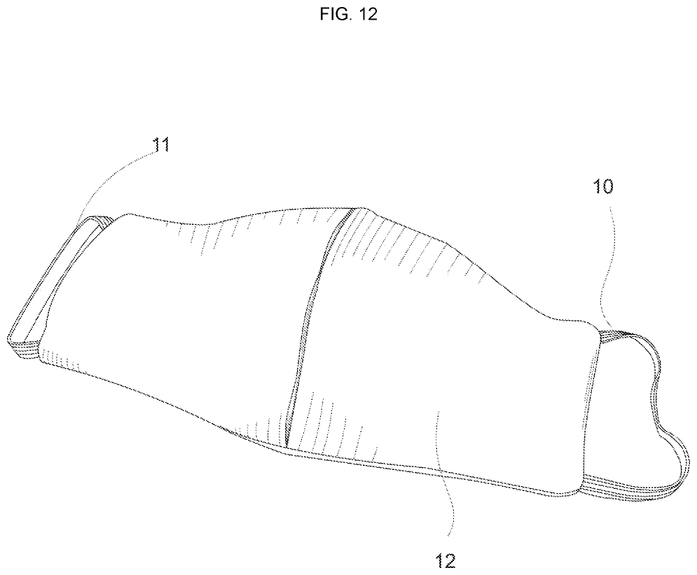

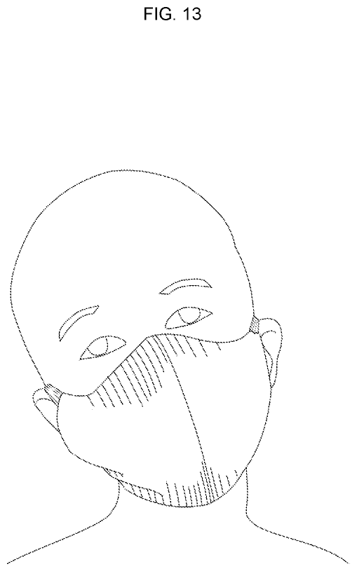

In FIG. 12, the third embodiment (Rider face mask designed for kids) of the present invention is disclosed and it consists of the outer layer 12 (front of the mask), and the straps 10 and 11. FIG. 13 discloses an illustration showing how the mask is worn by the user.

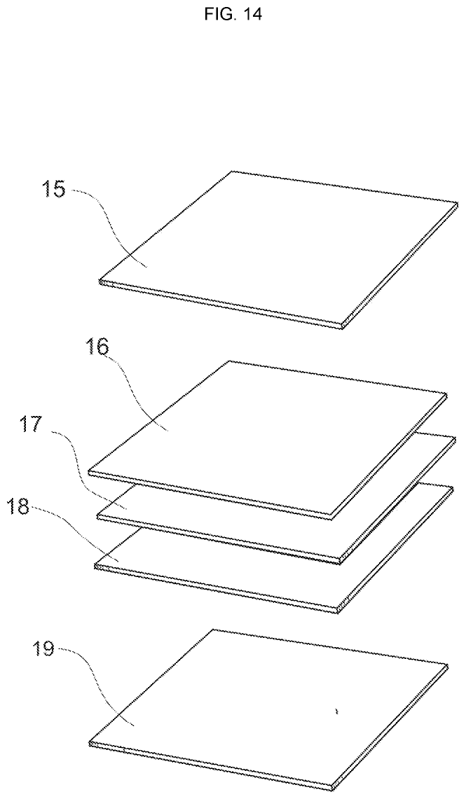

FIG. 14 shows the first fabric layer 15, three filtration layers 16, 17, 18 and the last layer/lining 19 which is the part that makes contact with the user's face of the first embodiment (shield face masks). It also consists of the first embodiment offers 99.9% filtration level protection in the adult version while the first embodiment for children and babies provides 100% filtration. The filtration layers are made of non-woven materials (polypropylene) and melt blown which are located inside the mask between the frontal and last layers.

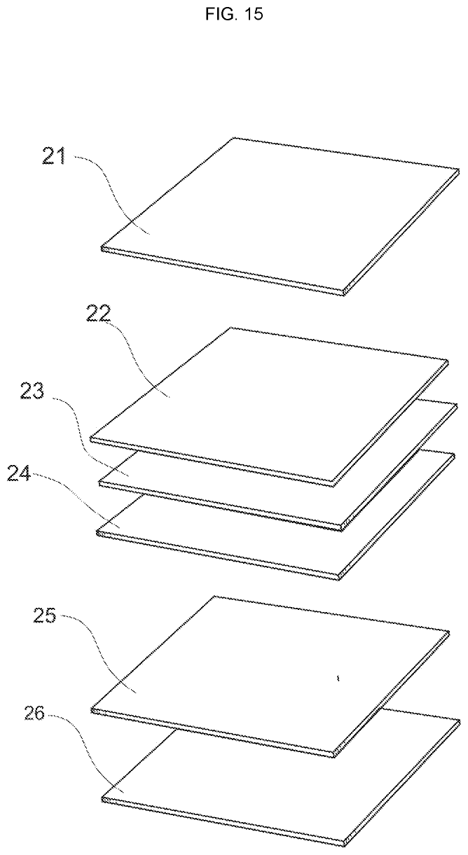

In FIG. 15, with respect to the second embodiment (Non N95 Olson face mask) of the present invention. This invention consists of the first layer of fabric 21 (the frontal part of the mask), three filtration layers pressed into one 22, 23, 24. It is also consists of the second to the last layer/lining 25 and the fabric layer that forms the pocket for fixing an (optional) additional filter 26. Like the first embodiment, these layers of filtration are made of non-woven materials (polypropylene) and melt blown which are located inside the mask between the frontal and last layers and offer PM2.5 level of filtration at 99.9%.

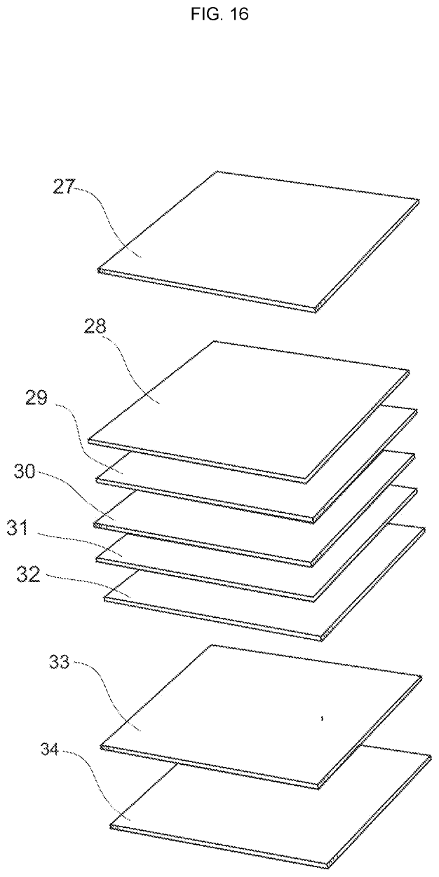

In FIG. 16, with respect to the second embodiment (N95 five layer Olson face mask) of the present invention. This invention consists of the first layer of fabric 27 (the frontal part of the mask), five filtration layers pressed into one 28, 29, 30, 31, 32 and also consists of the second to the last layer/lining 33 and the fabric layer that forms the pocket for fixing an (optional) additional filter 34.

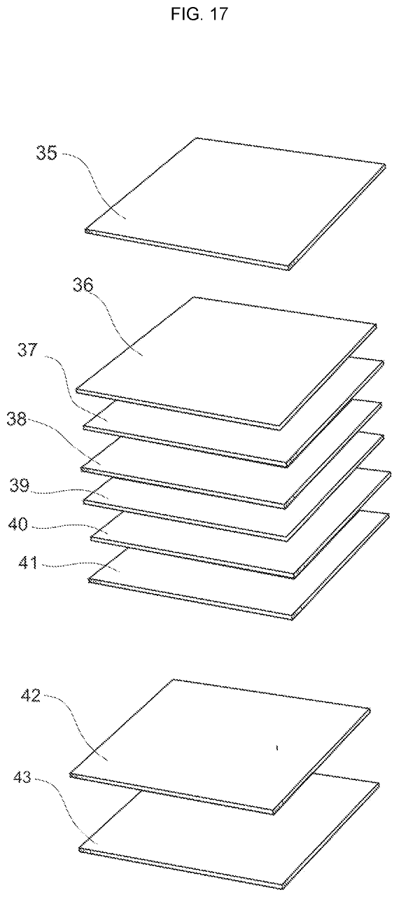

In FIG. 17 with respect to the second embodiment (N95 Olson 6 layer face mask) of the invention. This invention consists of the first layer of fabric 35 (the frontal part of the mask), six filtration layers pressed into one (N95 medical grade filter) 36, 37, 38, 39, 40, 41 the filtration layers offer filtering protection at 96.53%. FIG. 17 also consists of the second to the last layer 42 and the fabric layer that forms the pocket for fixing an (optional) additional filter 43.

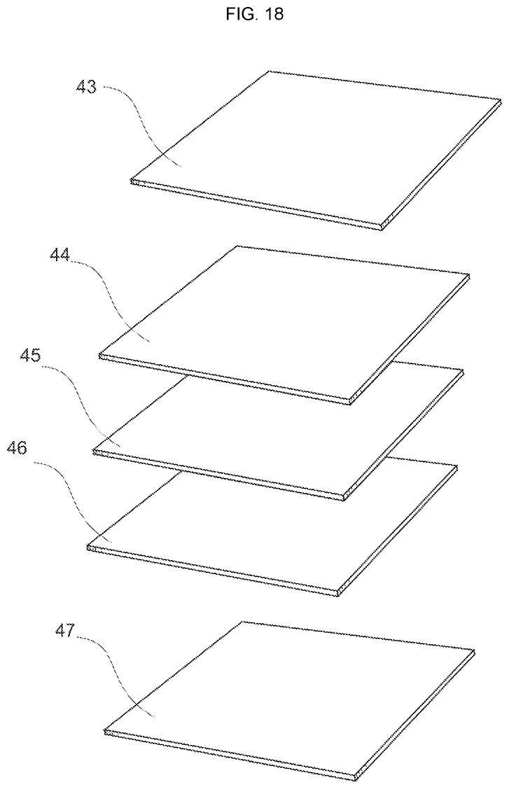

In FIG. 18, according third embodiment (rider face masks), the invention consists of the first layer of fabric 43 (the frontal part of the mask), three filtration layers pressed into one 44, 45, 46 and a last layer/lining 47. These layers are made of non-woven materials (polypropylene) and melt blown fabrics. Their function is to prevent the user from breathing harmful airborne pathogens into the lungs. The filtration level for the third embodiments for adults and children of the present invention is 99.8%.

### How the Invention is Used

The invention is used by wearing the headband/ear loops around the ears or the head of the user depending on how they are designed. The back of the mask consisting of the outer layer is pressed firmly around the nose and mouth areas thereby, allowing the user to freely breathe in clean air free from pathogens.

It's vital to note that for the present invention to be reused while maintaining the effectiveness of its functionality, the user must ensure that it is properly disinfected and washed according to the instructions presented below:
i. For disinfecting: Use a disinfecting spray that is human and textile friendly, sprayed for 2-3 seconds about 30 cm away from the face mask. (Both sides of the mask can be sprayed).
ii. For washing: Soak the mask for 15-30 minutes in lukewarm water with soap, rinse, allow the water to drain off the mask by gently pressing it in its natural folded position, then let it air dry in the shade in an open position and should only be worn when completely dry. The present invention should not be used when not completely dry, should not be squeezed, it should not be tumble dried. Washing the face mask in a machine will damage its filtration effectiveness. Hand wash is most recommended. It is very important to hang and completely air dry in order to eliminate any viruses, bacteria, or other pathogen that may have come into contact with the face mask.

1. A reusable and washable fabric/cloth medical grade face mask comprising a first fabric layer (frontal external layer), a plurality of filtration layers and 1-2 last fabric layer/lining accompanied with a bonding strap/s ear loops/head band;

2. A reusable and washable fabric/cloth medical grade face mask according claim 1 whereby in at least one embodiment, the filtration layers are made of non woven polypropylene melt blown material;

3. A reusable and washable fabric/cloth medical grade face mask according claim 1 whereby in another embodiment, at the filtration layers are made of medical grade N95 filtration material;

4. A reusable and washable fabric/cloth medical grade face mask according claims 1, 2 and 3 whereby the filtration layers are placed in between the first fabric/cloth layer on the frontal part of the mask and the last layer of the mask.

5. A reusable and washable fabric/cloth medical grade face mask according claims 1, 2, 3 and 4 whereby the first and last layers of the mask are made of top quality cotton material, polyester or any other suitable fabric, allowing the mask to be washed and reused without damaging the anti-microbial features of the filtration layers.
